(19) United States
(12) Patent Application Publication
(10) Pub. No.: US 2022/0036239 A1
(43) Pub. Date: Feb. 3, 2022

(54) SYSTEMS AND METHODS TO DEFINE THE CARD MEMBER VALUE FROM AN ISSUER PERSPECTIVE

(71) Applicant: MASTERCARD INTERNATIONAL INCORPORATED, Purchase, NY (US)

(72) Inventors: Deepak BHATT, Dehradun (IN); Tanmoy BHOWMIK, Bangalore (IN); Harsimran BHASIN, New Delhi (IN); Jessica PERETTA, Purchase, NY (US); Ganesh PRASAD, New York, NY (US)

(73) Assignee: MASTERCARD INTERNATIONAL INCORPORATED, Purchase, NY (US)

(21) Appl. No.: 17/386,452

(22) Filed: Jul. 27, 2021

(30) Foreign Application Priority Data
Jul. 29, 2020 (IN) 202011032556

(51) Int. Cl. G06N 20/00; G06K 9/62

(52) U.S. Cl. CPC G06N 20/00; G06K 9/6262; G06K 9/6257; G06K 9/6251; G06K 9/6234

(57) ABSTRACT

Systems and computer-implemented methods of modeling card member data to classify a card member into one of a plurality of classifications based on interchange fees derived from the use of a card issued to the card member. The modeling may handle data distribution from one time period to another time period to address unavailability and/or variability of historical data, implement a neural network architecture based on transformers and discriminators for accurate data scaling, perform data filling for missing data, and fine-tuning for card types that have less card member data, which may result in enhanced performance and faster convergence resulting in reduced computational time. Such fine-tuning may leverage uniform standardization in the neural network to handle multiple card types, which is facilitated through the use of the transformers and discriminators for data scaling.

### RELATED APPLICATIONS

This application claims priority to Indian Provisional Patent Application No. 202011032556, filed Jul. 29, 2020, which is incorporated herein by reference in its entirety.

### BACKGROUND

Machine-learning (ML) approaches may be able to provide insights on large-scale data for classification tasks. Generally speaking, classification may involve computer modeling that learns relationships between features from training data and target values corresponding to classifications. Such computer modeling may then classify an input dataset into one of the classifications based on the learned relationships. However, the foregoing may require the availability of a sufficient dataset to be modeled, low variability between training data and the validation dataset, continuity of the dataset, and/or other requirements. Oftentimes, some or all of these requirements are not met, rendering ML-based classification tasks inaccurate.

For example, it may be difficult to assess the value of a card member to whom a card is issued using ML approaches. For example, long-term historical data may be unavailable for card members, spending patterns and behaviors may change over time, and there may be periods of card inactivity. These and other issues with card member data may render it difficult to assess a value of a card member based on these ML approaches.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system of training and using an ML classifier that accounts for card member data variability over time to classify card members;

FIG. 2 illustrates an example distribution graph of interchange fees from card member data used to generate labels for training the classifier illustrated in FIG. 1;

FIG. 3 illustrates a schematic diagram of an example of ML modeling of features of card member data from the card member database and the labels illustrated in FIG. 2.

FIG. 4 illustrates an example schematic diagram of generating feature-label pairs for training the classifier illustrated in FIG. 1;

FIG. 5 illustrates an example architecture of training the classifier illustrated in FIG. 1 to account for variability of feature data over time;

FIG. 6 illustrates a data flow diagram of an example of Out Of Time (OOT) testing for the classifier illustrated in FIG. 1;

FIG. 7 illustrates a data flow diagram of an example of using the classifier illustrated in FIG. 1 in an inference mode;

FIG. 8 illustrates a plot of precision and a plot of recall measurements of the classifier illustrated in FIG. 1;

FIG. 9 illustrates an example of a method of training the classifier illustrated in FIG. 1;

FIG. 10 illustrates another example of a method of using the classifier illustrated in FIG. 1; and

FIG. 11 illustrates an example of a computer system that may be implemented by devices (such as the assessment system or device of issuer) illustrated in FIG. 1.

### DETAILED DESCRIPTION

The disclosure herein relates to methods and systems of training and using a machine-learning (ML) classifier that addresses technical issues of ML classification tasks. For purposes of illustration, in the examples that follow, the ML classifier may be described with reference to modeling a lifetime value of a card member based on interchange fees derived from the card in a given duration of time such as 12 months. However, the disclosure may relate to training and using an ML classifier in the context of modeling other types of data that may have insufficient datasets, data that may vary over time from one time period to a next time period, and/or has a lack of continuity.

The ML modeling described herein may classify a card member into one of a plurality of classifications based on interchange fees derived from the use of a card issued to the card member. An interchange fee may refer to a transaction fee that is paid to the issuer when the card is used, via a payment network, to pay a payee such as a merchant. Thus, the value of the card member from the perspective of the issuer may be assessed based on historical interchange fees generated based on use of the card issued to the card member (or use of other payment devices such as a digital wallet linked to a payment account). As previously noted, modeling a given card member may be difficult because sufficient historical data about the card member may be unavailable, card member spending varies from one time period to the next, and/or data on card member spending may not be continuous such when card member spending includes periods of inactivity. For example, there may be insufficient data on new card members to accurately assess card member value or insufficient data on certain card types that are less commonly issued than other card types. Furthermore, variability in card member spending patterns may result in an inability to appropriately scale historical data to future data because prior purchase histories may not match future purchases. While different scaling may be applied for different time periods in an attempt to address changes in data distribution, doing so may result in reduced performance since inputs to the model for training and testing will be scaled differently.

The ML modeling may handle data distribution from one time period to another time period to address the unavailability and/or variability of historical data, implement a neural network architecture based on transformers and discriminators for accurate data scaling, perform data filling (by filling data values with a default value such as zero) for missing data, and implement fine-tuning for card types that have less card member data, which may result in enhanced performance and faster convergence resulting in reduced computational time. Such fine-tuning may leverage uniform standardization in the neural network to handle multiple card types, which is facilitated through the use of the transformers and discriminators for data scaling.

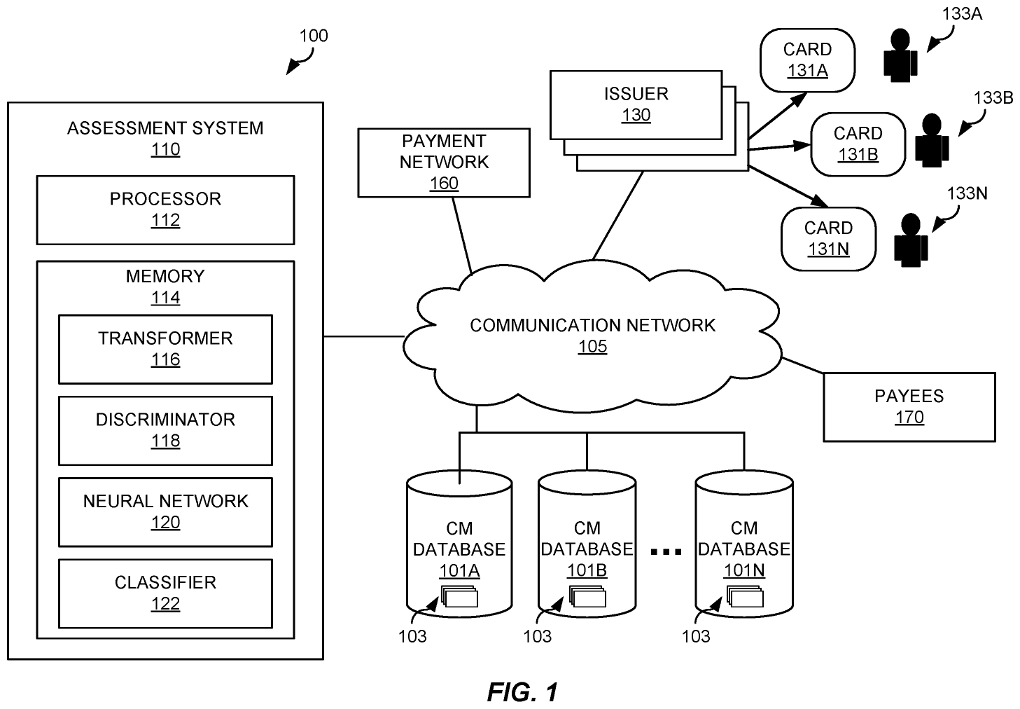

FIG. 1 illustrates an example of a system 100 of training and using an ML classifier (classifier 122) that accounts for card member data variability over time to classify card members 133 (illustrated as card members 133A, 133B, . . . , 133N). It should be noted that examples may refer to classifying card members 133. This should be understood to be interchangeable with classifying a card 131 or payment account associated with the card 131. System 100 may include, among other things, one or more card member databases 101 (illustrated as CM databases 101A, 101B, . . . , 101N), an assessment system 110, one or more issuers 130, a payment network 160, one or more payees 170, and/or other components.

CM databases 101 may each include features 103 of card members 133. A feature 103 may refer to a data value known about and stored in association with a card member 133 (or card 131). For example, a feature 103 may include an amount of interchange fees derived from use of the card 131 by card member 133, transaction histories, merchant category, overall purchase, card member profile data including creditworthiness information, and/or other data relating to a card member 133. In various examples described herein, a feature 103 (for univariate ML) may be used for training (such as in supervised ML). In some examples, multiple features 103 (for multivariate ML) may be used for training.

In some examples, a feature 103 may include a time series of interchange fees that may each be timestamped. In some of these examples, if the time series has missing data (such as in periods of inactivity of card use), the assessment system 110 may fill any missing data with default values, such as zero, as placeholders. Such default values may be later ignored during scaling and classification operations.

An issuer 130 may issue a plurality of cards 131 (illustrated as cards 131A, 131B, . . . , 131N) to respective card members 133. Cards 131 may refer to a payment card such as credit cards, debit cards, and other payment devices to card members 133. Some issuers 130 may issue different card types to different card members based on their respective credit profiles or other card member data. One card type may be more or less common than another card type. Thus, an exclusive card type may be issued to a lower number of card members compared to a more common card type. In these examples, different CM databases 101 may store card member data relating to different card types. For example, CM database 101A may store card member data for a first card type and CM database 101B may store card member data for a second card type. The CM database 101A may store more data including features 103 of card members 133 for the first card type than the CM database 101B that stores data including features 103 of card members 133 for the second card type because the second card type may be more exclusive (less commonly issued). Thus, it may be more difficult to assess a card member 133 that is issued the second card type compared to another card member 133 that is issued the first card type.

Payees 170 may include a recipient of a payment made with a card 131. Such payment may be processed via a payment network 160, such as the Mastercard® payment network. The payee 170 (such as through a payee acquirer) may be charged an interchange fee paid to the issuer 130 of the card 131.

The assessment system 110 may use the interchange fees generated by an issuer 130 and/or other features 103 to assess a value of the card members 133 from the perspective of the issuer 130. In other words, the value of a card member 133 may be determined based on an amount of interchange fees that the issuer 130 collects as a result of the card member 133 using the card 131 to make a transaction.

The assessment system 110 may include a processor 112, a memory 114, a transformer 116, a discriminator 118, a neural network 120, a classifier 122, and/or other components. The processor 112 may be a semiconductor-based microprocessor, a central processing unit (CPU), an application specific integrated circuit (ASIC), a field-programmable gate array (FPGA), and/or other suitable hardware device. Although the apparatus 100 has been depicted as including a single processor 112, it should be understood that the assessment system 110 may include multiple processors, multiple cores, or the like. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals.

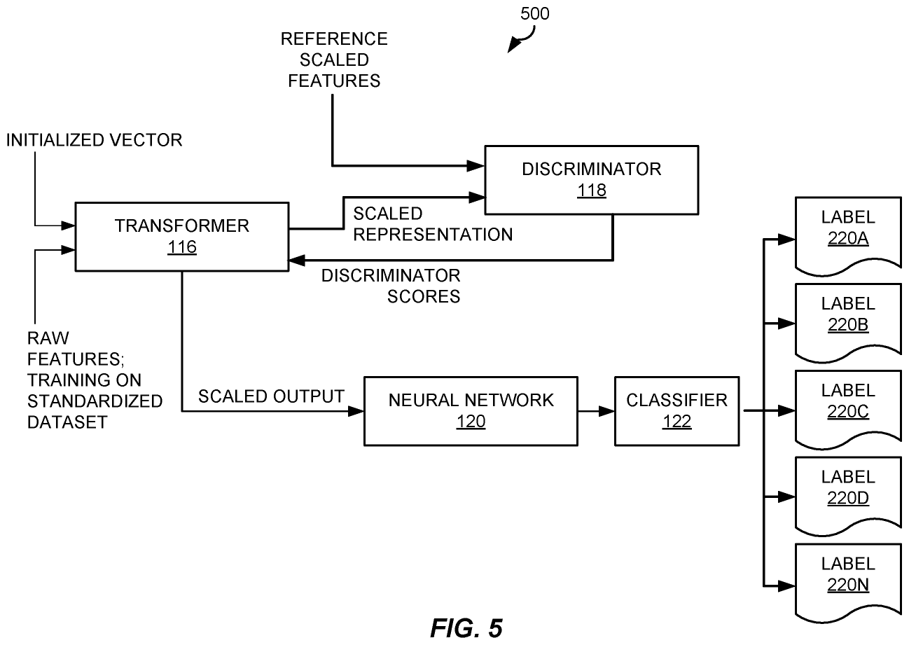

As will be described in further detail with respect to FIG. 5, the transformer 116 and the discriminator 118 may act in an adversarial fashion to train the scaling of features 103 by adjusting feature weights used by the transformer 116. After the training is complete, or simultaneously with such training, the neural network 120 may take as input the scaled features 103 and adjust classifier weights for training the classifier 122. The classifier 122 may output a classification of a given card member 133. Each classification may be represented by a respective label, which may be generated based on a distribution graph of interchange fees.

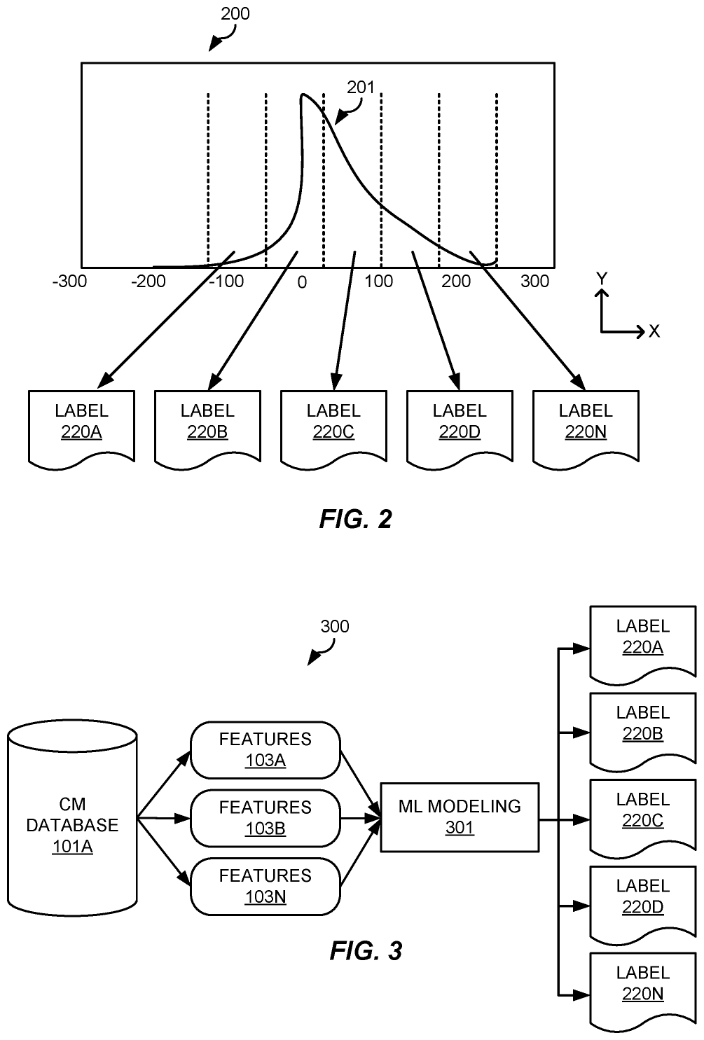

For example, FIG. 2 illustrates an example distribution graph 200 of interchange fees from card member data used to generate labels 220 (illustrated as labels 220A, 220B, 220C, 220D, . . . , 220N) for training the classifier illustrated in FIG. 1. A label 220 may refer to a term assigned to a card member 133 to denote a classification of the card member 133.

The distribution graph 200 may include a plot 201 that represents a distribution along the x-axis of an aggregate of interchange fees that an issuer 130 earns as a result of the use of cards 131 by corresponding card members 133 in a given time period. The time period may be one year, although other time periods may be used. For example, a given point in the plot 201 illustrated in distribution graph 200 may represent an aggregate interchange fee amount that an issuer 130 derives from the spending of a card member 133 using a corresponding card 131. Based on the distribution graph 200, a plurality of labels 220 may be derived into which card members 133 may be classified.

For example, a first label 220A may represent a top “M” amount of interchange fees derived by an issuer 130, where “M” is a percentage portion (such as top 20%) of the card members 133 observed in the time period. Card members 133 classified into the first label 220A may represent the highest value card members from the perspective of the issuer 130. A second label 220B may represent the next M amount of interchange fees derived by an issuer 130, and so forth. In some examples, each label 220 may include a text label, such as “Premium”, “High”, “Enhanced”, “Medium”, and “Low” that respectively correspond to the top 20%, top 20-40%, top 40-60%, top 60-80% and bottom 20%. Although five labels 220 are illustrated in the foregoing example, other numbers (and names) of labels 220 may be used. For example, the plot 201 may be divided into four labels 220 instead of five. Furthermore, labels 220 may be segmented in other ways, such as top 20%, top 20-50%, top 50-65%, and so forth, instead of an equal segmentation into labels 220.

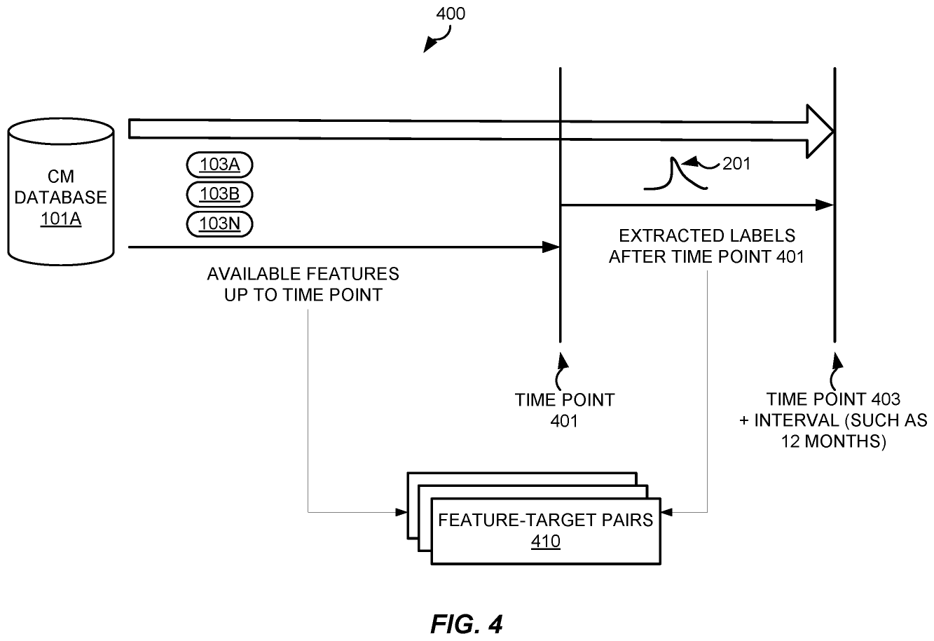

FIG. 3 illustrates a schematic diagram 300 of an example of ML modeling 301 of features 103 (illustrated in FIG. 3 as features 103A, 103B, . . . , 103N) of card member data from the card member database 101 and the labels 220 illustrated in FIG. 2. ML modelling 301 may refer to the process of training the transformer 116 to scale the features 103 to account for variability over time in the card member data through an adversarial relationship with the discriminator 118, training the classifier 122 through the neural network 120, and classifying card members 133 into labels 220. For supervised machine-learning, the ML modeling 301 may include generating feature-target pairs. For example, FIG. 4 illustrates an example schematic diagram 400 of generating feature-target pairs 410 for training the classifier illustrated in FIG. 1. Each feature-target pair 410 may include a feature 103 paired with a target (such as the interchange fee amount represented by a label 220) to be fed into the neural network 120 for training the classifier 122. In some examples, a feature-target pair 410 may be used to discover whether a feature 103 of a card member 133 maps with a respective level of aggregate interchange fees. For example, a particular time series of interchange fees derived from a card member 133 may be paired with a top 20% of aggregate interchange fees (indicated by a label 220A) of all card members to determine a mapping of the particular time series with the top 20%. Likewise, the particular time series of interchange fees derived from the card member 133 may be paired with a top 21-40% of aggregate interchange fees (indicated by a label 220B) of all card members to determine a mapping of the particular time series with the top 21-40%. This process may be repeated for the other labels (and other features) as well to generate multiple combinations of feature-target pairs 410 for supervised ML.

In some examples, as illustrated, the features 103 to be paired with targets may be restricted to features available from the card member database 101A up to a time point 401. For example, the time point 401 may be selected as an end of a previous year such as “Dec. 31, 2017.” Other time points 401 may be selected as well. Furthermore, the time point 401 may be adjusted from as the ML modeling is updated to reflect the availability of additional card member data over time. For example, a monthly update may include selection of Jan. 31, 2018 as the time point 401 and a yearly update may include selection of Dec. 31, 2018 as the time point 401.

In some examples, the labels 220 may be generated based on aggregate interchange fees collected between time point 401 and time point 403. Time point 403 may be determined based on time point 401 plus an interval of time, such as one year. In the foregoing example, the labels 220 may be generated based on aggregate interchange fees collected between time point 401 (Dec. 31, 2017) and time point 403 (Dec. 31, 2018). In this example, the feature-target pairs 410 may include all features 103 available through Dec. 31, 2017 (or only features available from a starting time through Dec. 31, 2017), and the target data may be based on labels generated for aggregate interchange fees collected between Dec. 31, 2017 and Dec. 31, 2018.

FIG. 5 illustrates an example architecture 500 of training the classifier 122 illustrated in FIG. 1 to account for variability of feature data over time. The architecture 500 may address loss due to incorrect scaling of features 103 and/or classification loss. The term “loss” may refer to errors in ML modeling. Loss due to incorrect scaling of features 103 may refer to loss that may occur because features are scaled based on historical data that may deviate beyond the observed values of the historical data. For example, the distribution of card member data may change significantly from one year to another year. In particular, card member spending in a recent year may vary from historical spending. Classification loss may refer to inaccurate classification weights applied to feature data during classification. Classification loss may be mitigated through the use of a loss function that minimize the loss with subsequent evaluations.

To scale features 103 across different time frames, the architecture 500 may include two networks, the transformer 116 and the discriminator 118. As used herein, the operation of “scale features 103” or “scaling features 103” may refer to scaling raw values of the features 103 extracted from card member data. In some examples, the transformer 116 and the discriminator 118 may act in an adversarial manner to train the transformer 116 to scale features 103. The transformer 116 may train on a standardized dataset of the features 103 based on a set of feature weights. The raw values of the features 103 may include a univariate feature, such as data representing a spend of a card member 133 aggregated over a period of time (such as weeks, months or years etc) of available data as illustrated in FIGS. 2-4. In some examples, the raw values may include multivariate features that include multiple feature variables, which may include the data representing the spend of the card member 133 aggregated over the period of time and one or more other features of the card member 133. In some examples, the multivariate features may include a combination of the other features (excluding the data representing the spend of the card member 133).

To facilitate training, the input to the transformer 116 may include an initialized vector that represents the feature weights. In some examples, the initialized vector may include a randomly initialized vector. In these examples, the set of feature weights may each be randomly initialized to be zero or near-zero (such as 0.1 or other near-zero feature weights for ML training as would be appreciated). Random initialization may disrupt symmetry so that different neurons in the network performs different scaling computations based on different initial feature weights, which may facilitate efficient learning to scale the features 103. Other types of initialized vectors may be used as well, including vectors that use zero initialization in which all feature weights are initialized at zero.

The transformer 116 may generate an output that includes a scaled representation of the features 103 based on the initialized vector and the standardized dataset of features 103. The output may be provided as input to the discriminator 118. The discriminator 118 may also take as input a set of reference scaled features. The reference scaled features may be used as a reference to guide training of the transformer 116. The reference scaled features may include scaled features from recent available data to the time point 401 illustrated in FIG. 4. “Recent available data” may refer to a period of time that ends in the time point 401. For example, “recent available data” may refer to one-year period of available features 103 that ends based on (such as at) the time point 401. In this manner, the reference scaled features may include those features 103 that are most recently available in the set of features 103 used for training the entire dataset of available features 103 for training.

The discriminator 118 may generate a discrimination score that indicates a level of error between the output of the transformer 116 and the reference scaled features. The discriminator score may therefore indicate how close the scaled representation of features output by the transformer 116 is to the reference scaled features, and therefore may represent the loss due to incorrect scaling of features. The discriminator 118 may provide the discrimination scores to the transformer 116 as feedback. The transformer 116 may adjust the set of feature weights based on the discrimination scores. For example, higher discrimination scores may result in greater adjustment to the feature weights applied by the transformer 116. The transformer 116-discriminator 118 may run in sync to learn the scaling of raw data. Such learning may iterate until a given threshold of accuracy is achieved, such as when the discrimination scores are less than a threshold discrimination score.

The scaled output of the transformer 116 may be provided as an input to the neural network 120 for training the classifier 122 to mitigate classifier loss. In some examples, the neural network 120 may include a dynamic recurrent neural network (RNN) to classify each card member 133 into a category identified by a label 220. A neural network, such as neural network 120, may refer to a computational learning system that uses a network of neurons to translate a data input of one form into a desired output. A neuron may refer to an electronic processing node implemented as a computer function, such as one or more computations. The neurons of the neural network may be arranged into layers. Each neuron of a layer may receive as input a raw value, apply a classifier weight to the raw value, and generate an output via an activation function. The activation function may include a log-sigmoid function, hyperbolic tangent, Heaviside, Gaussian, SoftMax function and/or other types of activation functions. The classifier weight may represent a measure of importance of the feature data at the neuron with respect to a relationship to a target result, such as a classification represented by a label 220. The output may be provided as input to another neuron of another layer. Thus, training a classifier by the neural network may include adjusting the classifier weights used by the neurons in the neural network. This process of neuron processing may be repeated until an output layer is reached.

In various examples, the transformer 116 and discriminator 118 may be trained together until the threshold of accuracy is achieved, and then the classifier 122 may be trained based on output of the trained transformer 116. In these examples, the scaled output of the transformer 116 may include scaled features output by the transformer 116 after training the transformer has been complete. Also in these examples, for classification, the discriminator 118 is inactivated and the set of feature weights used by the transformer 116 are no longer adjusted. Only classifier weights used by the classifier 122 may be trained.

In other examples, the transformer 116, discriminator 118, and the classifier 122 may be trained simultaneously. In these examples, the scaled output of the transformer 116 may include scaled representations that are output by the transformer 116 as the transformer is being trained.

In some examples, the classifier weights may be fine-tuned for data that has less observations. For example, this may occur when classifying card members 133 having card types (such as “elite” cards) that are less common than card types for which the feature weights were generated. Such fine-tuning may lead to enhanced performance and faster convergence, resulting in reduced computational time.

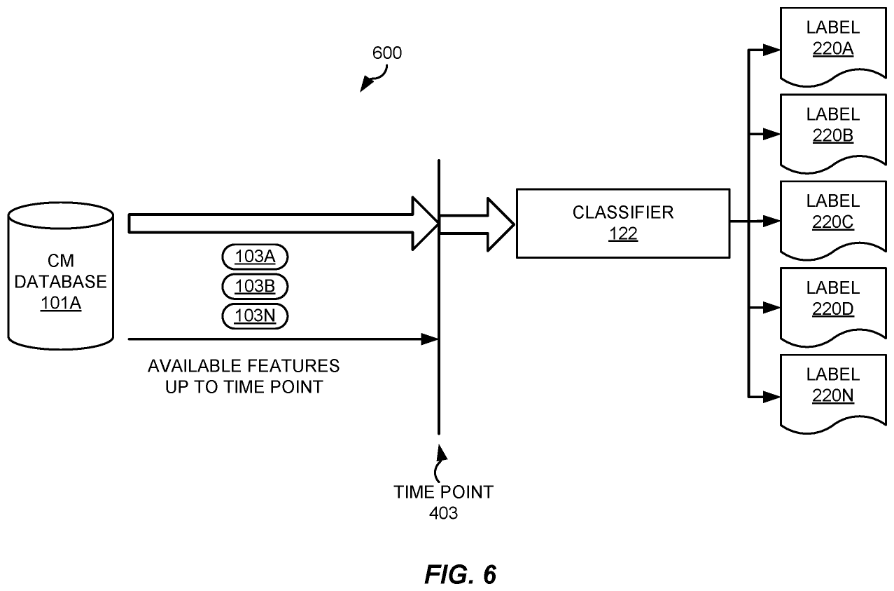

FIG. 6 illustrates a data flow diagram 600 of an example of OOT testing for the classifier illustrated in FIG. 1. Out of Time (OOT) may refer to a measurement in a regression analysis, using a later dataset than used for original training, that has statistically greater error at a defined risk factor from a regression line or multiple factor regression model than other measurements. Thus, an OOT measurement with respect to a given observation, or feature, may indicate that the observation is not representative of the distribution. In some examples, OOT testing may assess such OOT measurements and may be used to recalibrate modelling, such as by removing the features 103 that are associated with the OOT measurements. As illustrated, real-time OOT testing may include extracting available features 103 through time point 403, scaling these available features, and performing classification by the classifier 122. As used herein, real-time may refer to testing on a set of test or current data to assess classification performance, and more particularly to assess OOT measurements.

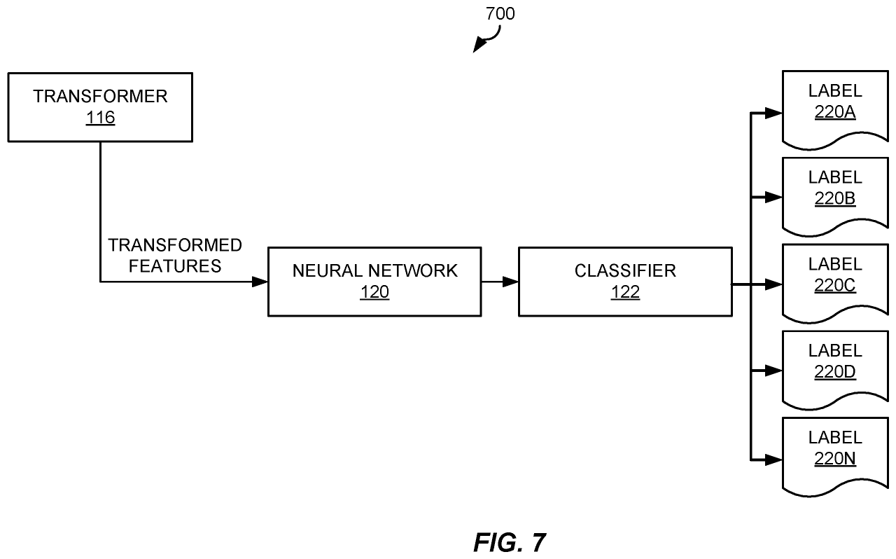

FIG. 7 illustrates a data flow diagram 700 of an example of using the classifier 122 illustrated in FIG. 1 in an inference mode. During the inference mode, features 103 of a card member 133 may be classified into a classification identified by a label 220. For example, features 103 of the card member 133 may be input to the transformer 116. The transformer 116 may generate transformed features by scaling the features 103 based on the learned feature weights described with respect to FIG. 5. The scaled features may be input to the neural network 120, which processes the scaled features according to the learned classifier weights, which are also described with respect to FIG. 5. Because the input is already scaled, standardization may be unnecessary. The neural network 120 may output respective probabilities that the card member 133 should be classified into a corresponding classification identified by a corresponding label 220 from among the plurality of labels 220. For example, the neural network 120 may output a first probability that the card member 133 belongs to a first classification identified by a first label 220A. The neural network 120 may output a second probability that the card member 133 belongs to a second classification identified by a second label 220B, and generate other probabilities for other labels 220. The probabilities may be input to the classifier 122, which may assign a label to the card member 133 based on the probabilities (such as by assigning the card member 133 to the label 220 corresponding to the highest probability. The neural network 120 may repeat the process of assigning a label 220 for other card members 133.

In some examples, within each classification identified by a label 220, the classifier 122 may rank the card members 133 based on their respective probabilities that they belong to that classification. For example, the classifier 122 may rank card members 133 in the top 20% of interchange fee generation (corresponding to the top 20% most valuable card members from the perspective of the issuer 130) based on their respective probabilities that they belong in the top 20%. The classifier 122 may similarly rank card members 133 within each of the other classifications as well.

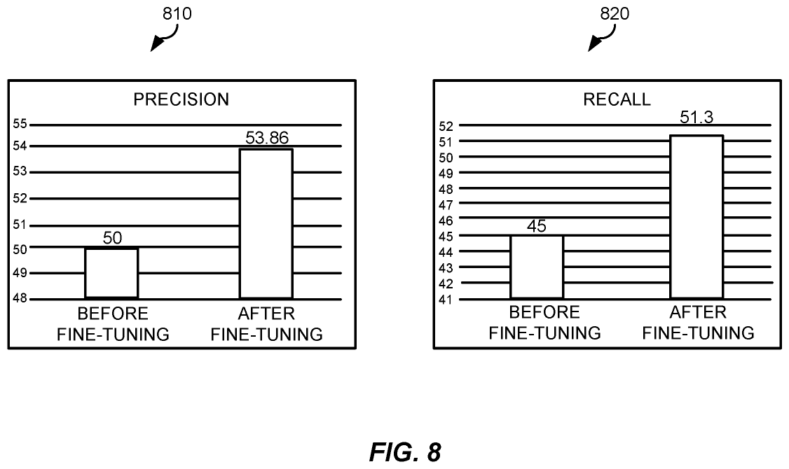

FIG. 8 illustrates a plot 810 of precision and a plot 820 of recall measurements of the classifier illustrated in FIG. 1. The plots show before fine-tuning and after fine-tuning feature weights learned from a first dataset of a first card type by applying a second dataset of a second card type (which is less observed data than the first card type). Thus, by using feature weights learned from the first dataset and fine-tuning the feature weights using the second dataset, ML modeling of the second dataset may be improved even though the second dataset may not have, on its own, sufficient available data.

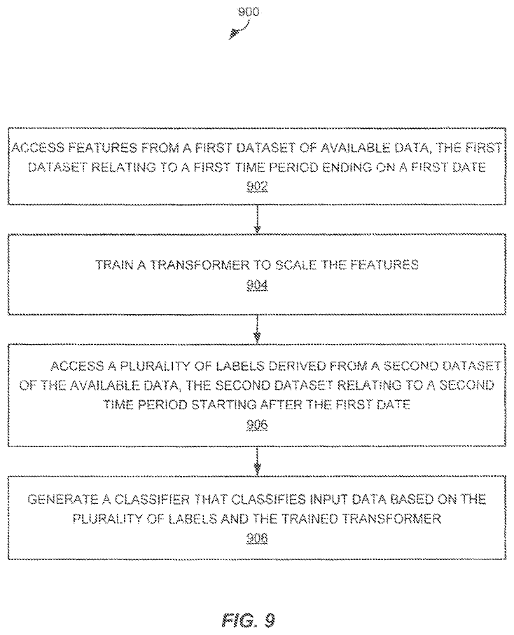

FIG. 9 illustrates an example of a method 900 of training the classifier 122 illustrated in FIG. 1. At 902, the method 900 may include accessing features (such as features 103) from a first dataset of available data, such as card member data of CM database 101. The first dataset may relate to a first time period ending on a first date (such as time point 401 illustrated in FIG. 4).

At 904, the method 900 may include training a transformer (such as transformer 116) to scale the features. An example of training the transformer is illustrated with respect to FIG. 5. In some examples, training the transformer may include implementing a discriminator (such as discriminator 118) that operates in an adversary manner with the transformer to adjust feature weights of the transformer. The feature weights may be used by the transformer scale the features. For example, the transformer may generate a scaled representation of the features based on the feature weights. The method 900 may include comparing, by the discriminator, the scaled representation of the features with reference scaled features corresponding to the first dataset. The method 900 may further include generating, by the discriminator, discrimination scores based on the comparison. Each discrimination score may indicate a level of difference between a scaled representation of a feature from among the scaled representation of the features and a corresponding reference scaled feature among the reference scaled features. The discriminator may provide the discrimination scores to the transformer and the method 900 may include adjusting, by the transformer, the feature weights based on the discrimination scores to adjust generation of the scaled representation of the features. In some examples, the foregoing process of adjusting the feature weights via training of the transformer and the discriminator may repeat until one or more of the discrimination scores are each within a threshold level of error, which may be a predefined threshold.

In some examples, the method 900 may include training the transformer and the discriminator to generate the scaled representation of the features and then training the classifier after the transformer and the discriminator are trained. In other examples, the method 900 may include training the transformer, the discriminator, and the classifier simultaneously.

In some examples, the method 900 may include fine-tuning classifier weights derived from the available data based on a second set of available data that is less in quantity than the available data. In these examples, the fine-tuning may include accessing the classifier weights that were learned from training the transformer and adjusting the feature weights based on the second set of available data. In this manner, the method 900 may include fine-tuning classifier weights for the second set of available data. For example, the available data may relate to the most common card type issued to card members 133 by the issuer 130. The second available data may relate to a less common card type (such as an “elite” card) issued to card members 133 by the issuer 130. Thus, the quantity of the second available data may be less in quantity than the quantity of the available data for the most common card type. As would be appreciated, data sparseness may result in data training that is not sufficient for data modeling.

At 906, the method 900 may include accessing a plurality of labels (such as labels 220) derived from a second dataset of the available data. The second dataset may relate to a second time period starting after the first date. At 908, the method 900 may include generating a classifier (such as classifier 122) that classifies input data based on the plurality of labels and the trained transformer. For example, the input data may include card member data relating to card member 133. The classifier may classify the card member 133 into a label 220 based on features of the card member data.

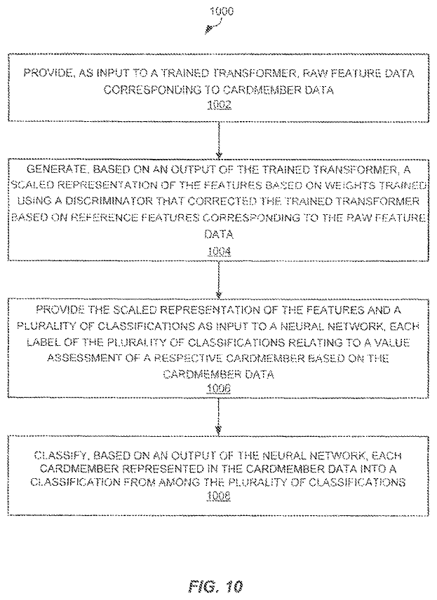

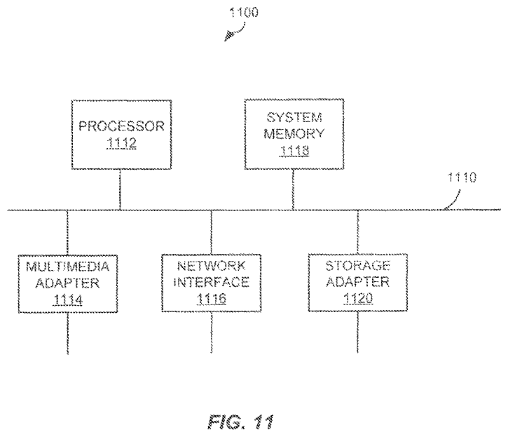

FIG. 10 illustrates another example of a method 1000 of using the classifier 122 illustrated in FIG. 1. At 1002, the method 1000 may include providing, as input to a trained transformer, raw feature data corresponding to card member data. At 1004, the method 1000 may include generating, based on an output of the trained transformer, a scaled representation of the features based on weights trained using a discriminator that corrected the trained transformer based on reference features corresponding to the raw feature data. At 1006, the method 1000 may include providing the scaled representation of the features and a plurality of classifications as input to a neural network, each label of the plurality of classifications relating to a value assessment of a respective card member based on the card member data. At 1008, the method 1000 may include classifying, based on an output of the neural network, each card member represented in the card member data into a classification from among the plurality of classifications.

FIG. 11 illustrates an example of a computer system 1100 that may be implemented by devices (such as the assessment system 110 or device of issuer 130) illustrated in FIG. 1. The computer system 1100 may be part of or include the system 100 to perform the functions and features described herein. For example, various ones of the devices of system 100 may be implemented based on some or all of the computer system 1100.

The computer system 1100 may include, among other things, an interconnect 1110, a processor 1112, a multimedia adapter 1114, a network interface 1116, a system memory 1118, and a storage adapter 1120.

The interconnect 1110 may interconnect various subsystems, elements, and/or components of the computer system 1100. As shown, the interconnect 1110 may be an abstraction that may represent any one or more separate physical buses, point-to-point connections, or both, connected by appropriate bridges, adapters, or controllers. In some examples, the interconnect 1110 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 1110 may allow data communication between the processor 1112 and system memory 1118, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 1112 may control operations of the computer system 1100. In some examples, the processor 1112 may do so by executing instructions such as software or firmware stored in system memory 1118 or other data via the storage adapter 1120. In some examples, the processor 1112 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 1114 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 1116 may provide the computer system 1100 with an ability to communicate with a variety of remove devices over a network such as the communication network 105 illustrated in FIG. 1. The network interface 1116 may include, for example, an Ethernet adapter, a Fibre Channel adapter, and/or other wired- or wireless-enabled adapter. The network interface 1116 may provide a direct or indirect connection from one network element to another, and facilitate communication and between various network elements.

The storage adapter 1120 may connect to a standard computer readable medium for storage and/or retrieval of information, such as a fixed disk drive (internal or external).

Other devices, components, elements, or subsystems (not illustrated) may be connected in a similar manner to the interconnect 1110 or via a network such as the communication network 105. The devices and subsystems can be interconnected in different ways from that shown in FIG. 11. Instructions to implement various examples and implementations described herein may be stored in computer-readable storage media such as one or more of system memory 1118 or other storage. Instructions to implement the present disclosure may also be received via one or more interfaces and stored in memory. The operating system provided on computer system 1100 may be MS-DOS®, MS-WINDOWS®, OS/2®, OS X®, IOS®, ANDROID®, UNIX®, Linux®, or another operating system.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “130A-N” does not refer to a particular number of instances of 130, but rather “two or more.”

The rules database 151, directory database 153, the ARN database 155, and/or other databases described herein may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system of training a machine-learning classifier that accounts for variability in data distributions over time, comprising:
a processor programmed to:
access features from a first dataset of available data, the first dataset relating to a first time period ending on a first date;
train a transformer to scale the features;
access a plurality of labels derived from a second dataset of the available data, the second dataset relating to a second time period starting after the first date; and
generate a classifier that classifies input data based on the plurality of labels and the trained transformer.

2. The system of claim 1, wherein to train the transformer, the processor is further programmed to implement a discriminator that operates in an adversary manner with the transformer to adjust feature weights of the transformer.

3. The system of claim 2, wherein the transformer is to:
generate a scaled representation of the features based on the feature weights; and
wherein the discriminator is to:
compare the scaled representation of the features with reference scaled features corresponding to the first dataset;
generate discrimination scores based on the comparison, each discrimination score indicating a level of difference between a scaled representation of a feature from among the scaled representation of the features and a corresponding reference scaled feature among the reference scaled features; and
provide the discrimination scores to the transformer, wherein the transformer is to adjust the feature weights based on the discrimination scores to adjust generation of the scaled representation of the features.

4. The system of claim 3, wherein the transformer is to adjust feature weights until one or more of the discrimination scores are each within a threshold level of error.

5. The system of claim 3, wherein to train the transformer, the processor is further programmed to:
train the transformer and the discriminator to generate the scaled representation of the features; and
train the classifier after the transformer and the discriminator are trained.

6. The system of claim 3, wherein to train the transformer, the processor is further programmed to:
train the transformer, the discriminator, and the classifier simultaneously.

7. The system of claim 2, wherein the processor is further programmed to fine-tune classifier weights derived from the available data based on a second set of available data that is less in quantity than the available data, and wherein to fine-tune, the processor is programmed to:
access the classifier weights; and
adjust the classifier weights based on the second set of available data.

8. The system of claim 7, wherein the available data relates to a first card type of respective card members and the second set of available data relates to a second card type of respective card members.

9. The system of claim 1, wherein the first dataset comprises univariate data relating to a plurality of card members, and wherein the features comprise a time series of data relating to an amount of spending of each of the plurality of card members.

10. The system of claim 1, wherein the first dataset comprises multivariate data relating to a plurality of card members, and wherein the features comprise at least a time series of data relating to an amount of spending of each of the plurality of card members and at least one other characteristic of each of the plurality of card members.

11. The system of claim 1, wherein each label of the plurality of labels comprises a card member category that is based on a level of spend of a card member.

12. The system of claim 11, wherein the classifier generates a respective probability that the card member belongs to a given card member category.

13. The system of claim 12, wherein the processor is further programmed to:
rank, within each card member category, each card member based on the respective probability that each card member CM belongs to the card member category.

14. A method of training a machine-learning classifier that accounts for variability in data distributions over time, comprising:
accessing, by a processor, features from a first dataset of available data, the first dataset relating to a first time period ending on a first date;
training, by the processor, a transformer to scale the features;
accessing, by the processor, a plurality of labels derived from a second dataset of the available data, the second dataset relating to a second time period starting after the first date; and
generating, by the processor, a classifier that classifies input data based on the plurality of labels and the trained transformer.

15. The method of claim 14, wherein training the transformer comprises:
implementing a discriminator that operates in an adversary manner with the transformer to adjust feature weights of the transformer.

16. The method of claim 15, further comprising:
generating, by the transformer, a scaled representation of the features based on the feature weights; and
comparing, by the discriminator, the scaled representation of the features with reference scaled features corresponding to the first dataset;
generating, by the discriminator, discrimination scores based on the comparison, each discrimination score indicating a level of difference between a scaled representation of a feature from among the scaled representation of the features and a corresponding reference scaled feature among the reference scaled features;
providing, by the discriminator, the discrimination scores to the transformer; and
adjusting, by the transformer, the feature weights based on the discrimination scores to adjust generation of the scaled representation of the features.

17. The method of claim 16, wherein further comprising:
adjusting, by the transformer, feature weights until one or more of the discrimination scores are each within a threshold level of error.

18. The method of claim 16, wherein training the transformer comprises:
training the transformer and the discriminator to generate the scaled representation of the features; and
training the classifier after the transformer and the discriminator are trained.

19. The method of claim 16, wherein training the transformer comprises:
training the transformer, the discriminator, and the classifier simultaneously.

20. The method of claim 15, further comprising:
fine-tuning classifier weights derived from the available data based on a second set of available data that is less in quantity than the available data, and wherein fine-tuning comprises:
accessing the classifier weights; and
adjusting the classifier weights based on the second set of available data.
